(19) United States
(12) Patent Application Publication
(10) Pub. No.: US 2022/0396105 A1
(43) Pub. Date: Dec. 15, 2022

(54) Trailer Moving Assist Device

(71) Applicants: Duane Stombaugh, Spring Lake Park, MN (US); Tim Stombaugh, Spring Lake Park, MN (US)

(72) Inventors: Duane Stombaugh, Spring Lake Park, MN (US); Tim Stombaugh, Spring Lake Park, MN (US)

(21) Appl. No.: 17/829,473

(22) Filed: Jun. 1, 2022

Related U.S. Application Data
(60) Provisional application No. 63/208,795, filed on Jun. 9, 2021.

(51) Int. Cl. B60D 1/24; B60D 1/167

(52) U.S. Cl. CPC B60D 1/24; B60D 1/167

(57) ABSTRACT

A trailer pulling assist includes a jack that is vertically elongated. A bracket is attached to the jack and engages a tongue of a trailer. A wheel mount is attached to and extends downwardly from the jack. The wheel mount is rotatable about a longitudinal axis of the jack when the bracket is attached to the trailer tongue. At least one wheel is rotatably mounted on an axle of the wheel mount. A coupler is mounted on the wheel mount. An elongated handle is removably coupled to the coupler.

### CROSS-REFERENCE TO RELATED APPLICATIONS

I hereby claim the benefit under 35 U.S.C. Section 119(e) of U.S. Provisional application 63/208,795 filed Jun. 9, 2021.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trailer moving assisting device and more particularly pertains to a new trailer moving assisting device for providing leverage for a person both in steering and moving a trailer such that the trailer can be moved by hand and without the help of a motorized vehicle. In particular, the device allows connection to the tongue of a trailer with a wheeled jack and a handle attached to the jack which allows steering of the jack. The handle is elongated such that the user is positioned forward of the tongue and thereby can pull on the handle to move the jack. A length of the handle is generally orientated perpendicular to an axle of the wheel on the jack so that as the user moves lateral relative to the tongue, the wheel will remain directed at the user.

### (2) Description of Related Art Including Information Disclosed Under 37 CFR 1.97 and 1.98

The prior art relates to trailer moving assisting devices that are typically attachable to a trailer to allow it some freedom to roll and be directed by utilizing a steerable jack when the trailer is being pushed or driven by an electric motor.

### BRIEF SUMMARY OF THE INVENTION

An embodiment of the disclosure meets the needs presented above by generally comprising a jack that is vertically elongated. A bracket is attached to the jack and engages a tongue of a trailer. A wheel mount is attached to and extends downwardly from the jack. The wheel mount is rotatable about a longitudinal axis of the jack when the bracket is attached to the trailer tongue. At least one wheel is rotatably mounted on an axle of the wheel mount. A coupler is mounted on the wheel mount. An elongated handle is removably coupled to the coupler.

In another embodiment, a method of moving a trailer includes providing a trailer having a tongue and attaching a bracket to the tongue of the trailer. A jack is attached to the bracket and extends downwardly therefrom. A wheel mount is attached to and extends downwardly from the jack, wherein the wheel mount is rotatable about a longitudinal axis of the jack when the bracket is attached to the trailer tongue. At least one wheel is rotatably mounted on an axle of the wheel mount. A coupler is mounted on the wheel mount. A handle is then releasably attached to the coupler such that the handle extends away from the wheel mount. The handle is elongated and including a grip is positioned opposite of the coupler. A user grips the grip and pulls the handle to in turn pull the trailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a trailer pulling assist and method according to an embodiment of the disclosure.

FIG. 2 is a side isometric view of a handle of an embodiment of the disclosure.

FIG. 3 is a bottom view of an embodiment of the disclosure.

FIG. 4 is a side view of an embodiment of the disclosure.

FIG. 5 is a rear isometric view of an embodiment of the disclosure.

FIG. 6 is a front isometric view of an embodiment of the disclosure.

FIG. 7 is a top and rear isometric in-use view of an embodiment of the disclosure.

FIG. 8 is a side in-use view of an embodiment of the disclosure.

### DETAILED DESCRIPTION OF THE INVENTION

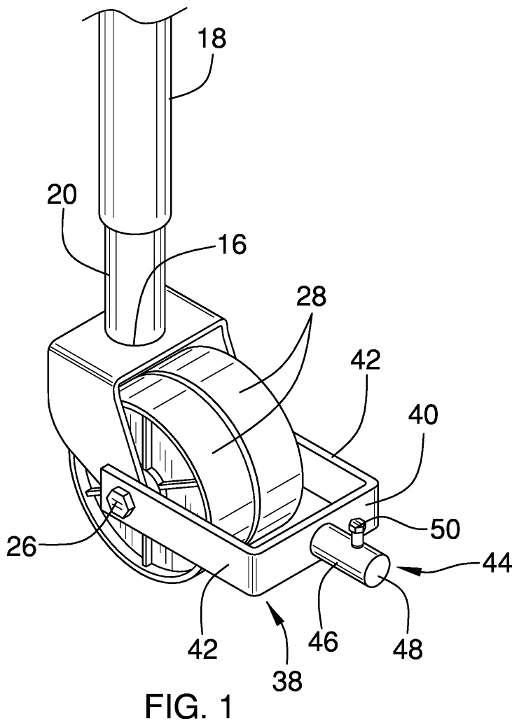

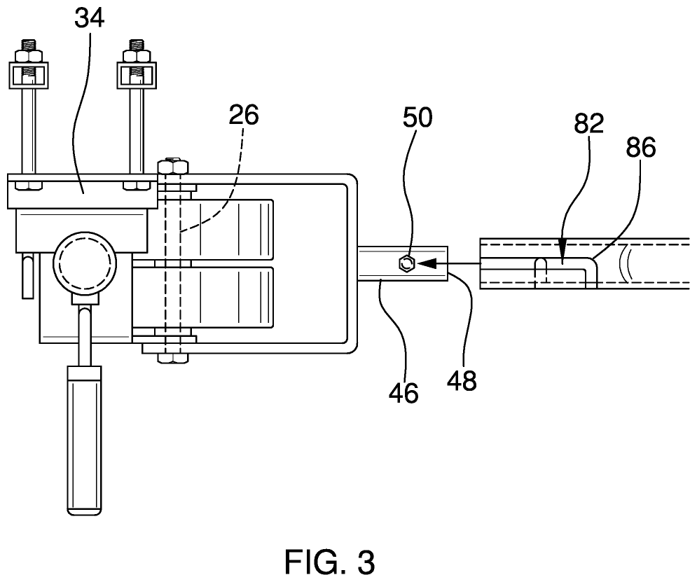

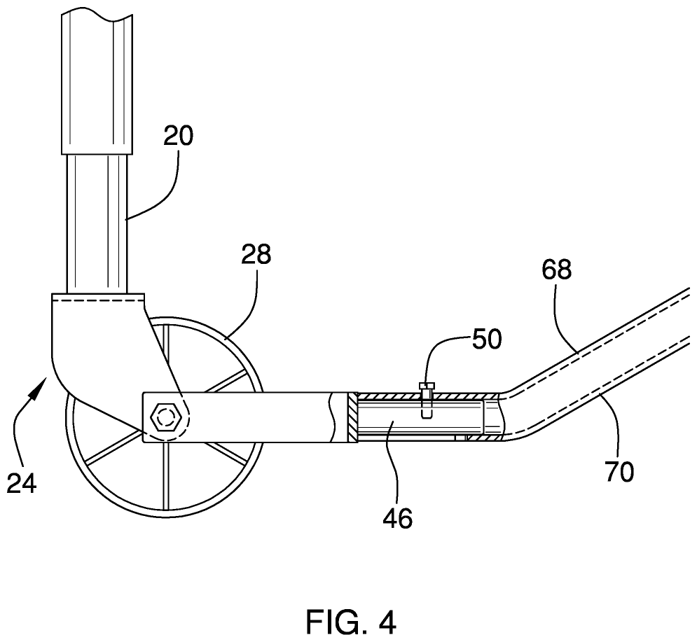

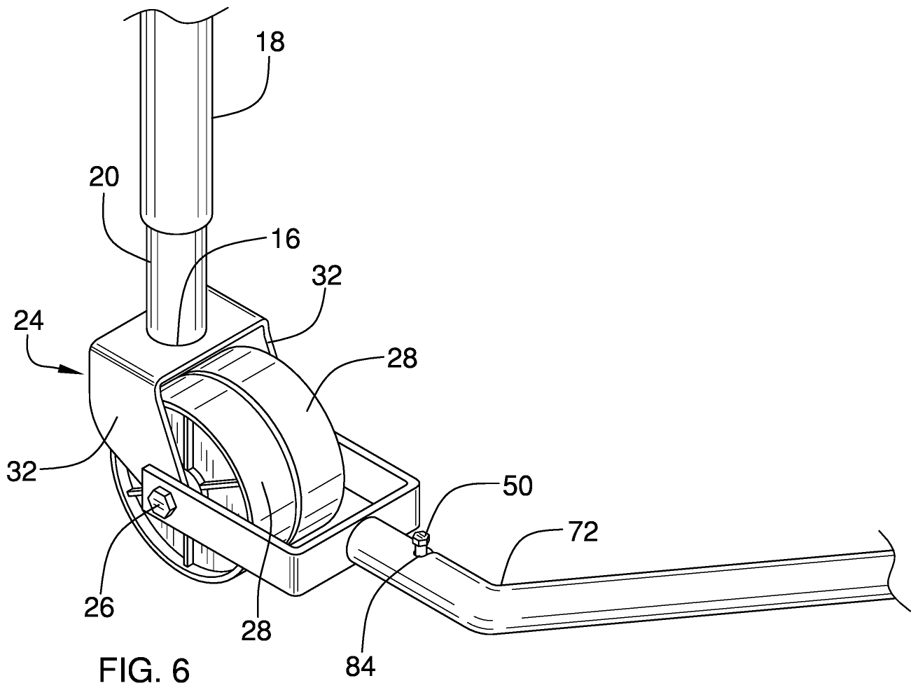

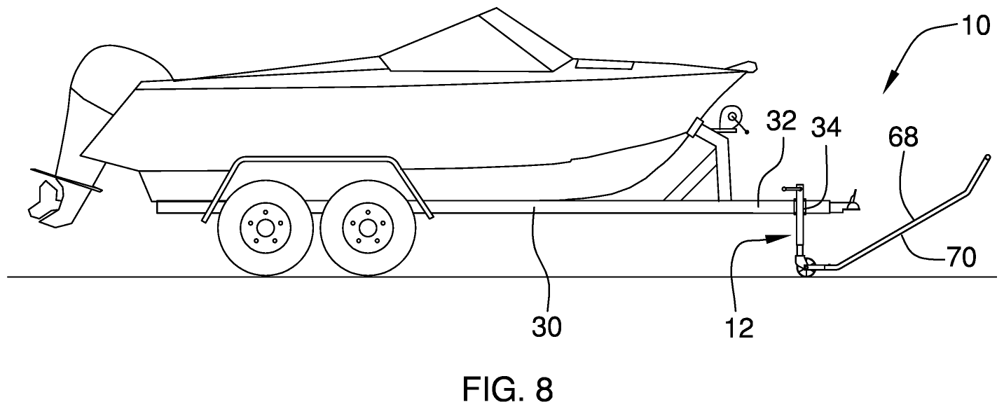

With reference now to the drawings, and in particular to FIGS. 1 through 8 thereof, a new trailer moving assisting device embodying the principles and concepts of an embodiment of the disclosure and generally designated by the reference numeral 10 will be described.

As best illustrated in FIGS. 1 through 8, the trailer pulling assist and method 10 generally comprises a jack 12 that is vertically elongated and has a top end 14 and a bottom end 16, and which typically includes an upper section 18 and a lower section 20 telescopically coupled to each other. The jack 12 is generally conventional and a height of the jack 12 is increased or decreased when the jack 12 is actuated by means of a crank 22. A wheel mount 24 is attached to and extends downwardly from the jack 12 and includes a horizontally orientated axle 26 upon which is rotatably coupled at least one wheel 28. The above is often found in conventional trailer jacks combining jacks and wheels to lift a front end of a trailer 30 to more easily move the trailer 30, particularly on a flat surface such as within a garage. The wheel mount 24 is rotatable about an axis that is also a vertically orientated longitudinal axis of the jack 12. However, the wheel mount 24 may be offset from the longitudinal axis of the jack 12 wherein the rotational axis of the wheel mount 24 is spaced from and orientated parallel to the longitudinal axis of the jack 12. This allows the wheel 28 to be turned to face a desired direction of movement. The wheel mount 24 may include a pair of lateral walls 32, wherein the axle 26 extends through the lateral walls 32. The wheel 28, or a pair of wheels 28, is positioned between the lateral walls 32.

A bracket 34 is attached to the jack 12 and will most typically be positioned on the upper section 18 whereas the wheel mount 24 is attached to the lower section 20. The lower section 20 may be rotatable with respect to the upper section 18 to allow the wheel mount 24 to rotate relative to the trailer 30 and bracket 34 or the wheel mount 24 may be rotationally coupled to the lower section 20. The bracket 34 is configured to engage a tongue 36 of the trailer 30. The bracket 34 is generally conventional and extends around the tongue 36 and may be attached to a plate mechanically or permanently attached to the jack 12.

A coupler 38 is mounted on the wheel mount 24. In one embodiment the coupler 38 includes a saddle with a central member 40 and a pair of arms 42 extending away from the central member 40. Each of the arms 42 is attached to the axle 26 wherein the lateral walls 32 are positioned between the arms 42. The coupler further includes a first mating member 44. The first mating member 44 of this embodiment includes a post 46 that is attached to the central member 40. The post 46 extends in an opposite direction from the central member 40 with respect to the arms 42. A detent is mounted on the post. In one embodiment, the post 46 has a distal end 48 with respect to the central member 40. The detent 50 is mounted on a peripheral surface of the post 46 and is positioned between the central member 40 and the distal end 48, though the detent 50 may be positioned directly adjacent to the distal end 48.

A handle 52 is removably coupled to the coupler 38. The handle 52 is elongated and will have a length between 3.0 feet and 6.0 feet. The handle 52 more particularly includes an elongated member 60 having a first end 62, a second end 64 and a peripheral surface 66 extending between the first 62 and second 64 ends. For clarification purposes, the peripheral surface 66 has a top side 68 and a bottom side 70. The top side 68 has a lower bend 72 therein positioned adjacent to the first end 62 that forms an angle between 145° and 175°. The top side 68 has an upper bend 74 therein positioned adjacent to the second end 64 that forms an angle between 145° and 175°. The lower 72 and upper 74 bends in the elongated member 60 cause the handle 52 to extend outwardly and upwardly to facilitate gripping of the handle 52 without bending over while ensuring the handle 52 extends outwardly away from the trailer 30 to clear any objects positioned thereon.

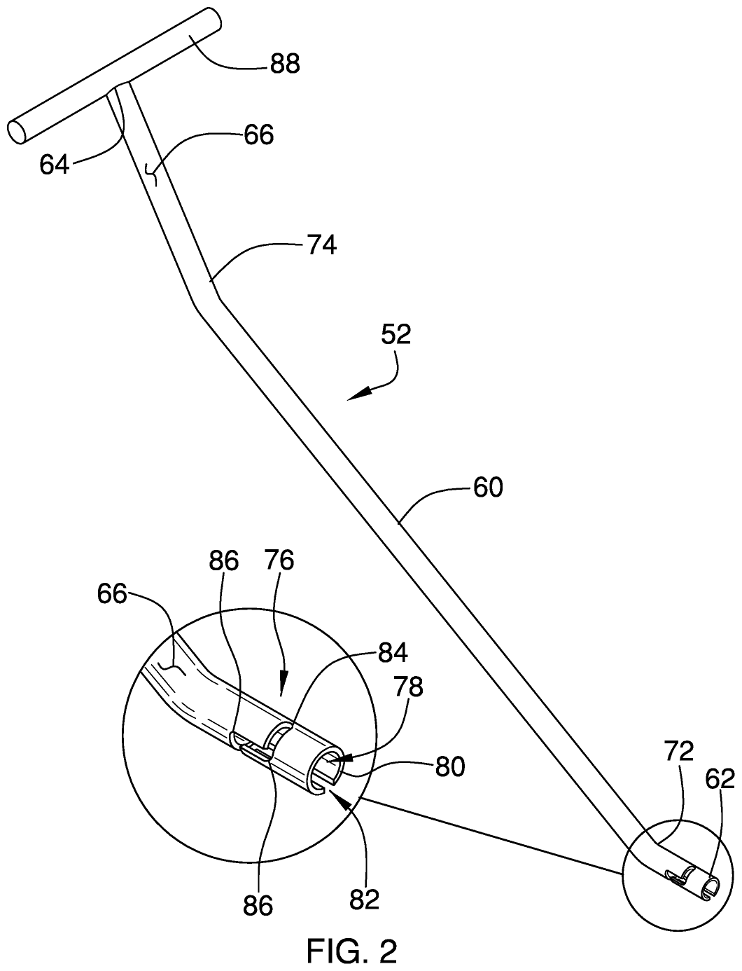

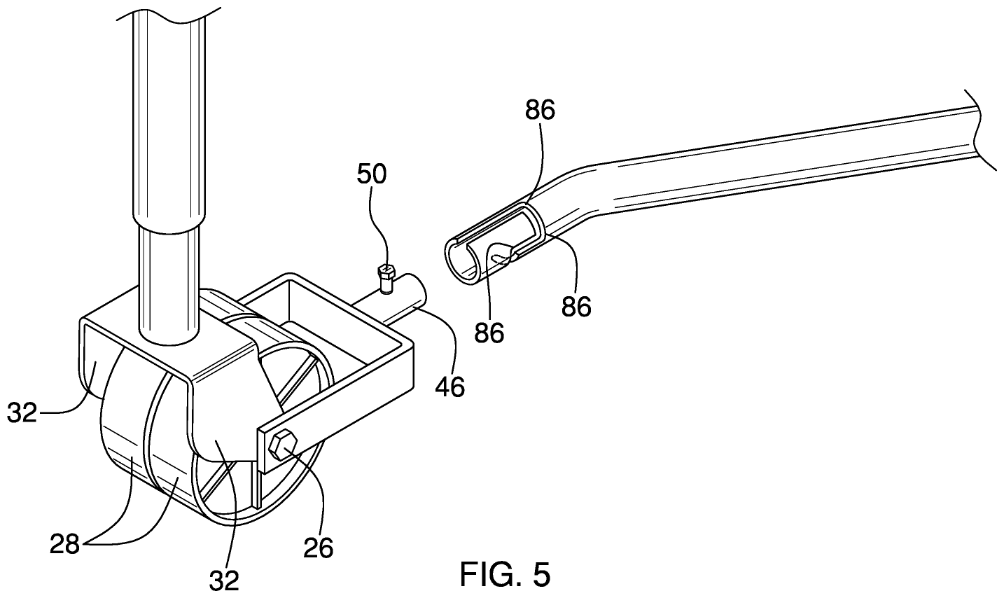

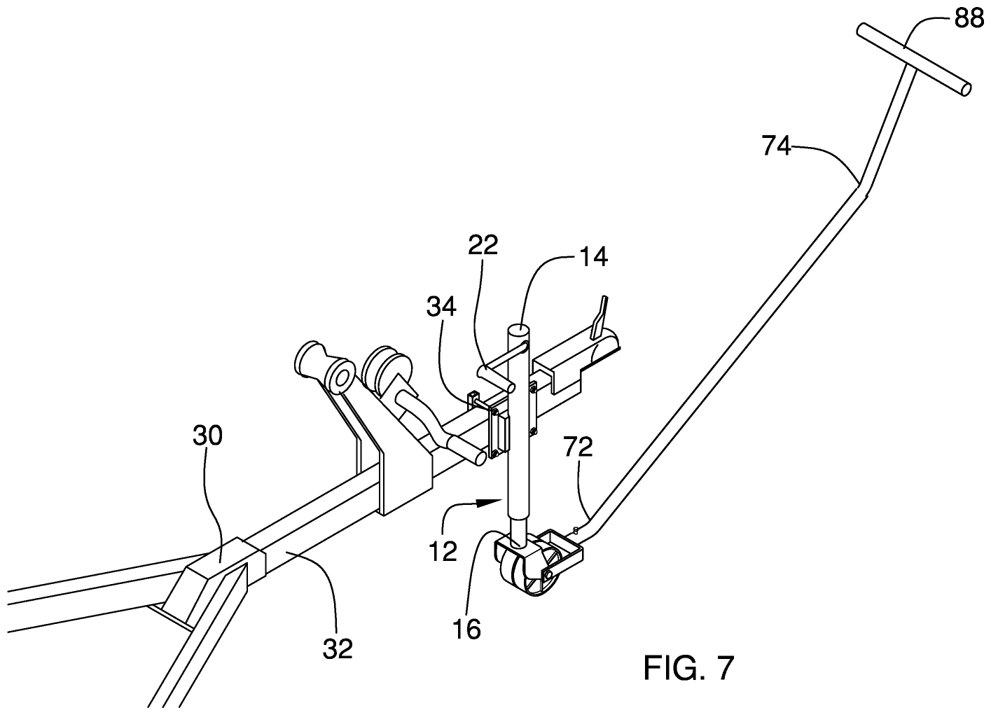

As shown in the enlarged inset view of FIG. 2, the handle 52 further includes the first end 62 comprising a second mating member 76 configured to releasably engage the first mating member 44. In this embodiment, the second mating member 76 comprises a sleeve 78 for receiving the post 46. An outer end 80 of the sleeve 78 has a slot 82 extending therein to receiver the detent 50. The slot 82 has a terminal end 84 and, moreover, the slot 82 has at least one bend 86 therein to retain the detent 50 in the slot 82 when the detent 50 is abutted against the terminal end 84. The top side 68 of the elongated member 60 faces upwardly when the detent 50 abuts the terminal end 84. The bend 86, or bends 86, in the slot 82, ensures that the detent 50 does not slide out of the slot 82 and causes the handle 52 to have the correct orientation as is shown in FIG. 7. FIG. 5 shows the slot 82 having three 90° bends 86 therein with the terminal end 84 being on the top side 68 of the elongated member 52. This positioning also causes a line extending through the first 62 and second 64 ends to be orientated perpendicular to the axle 26 to increase leverage for the user when the user is altering a direction of the axle 26 by lateral movement of the second end 64.

It is contemplated that the first 44 and second 76 mating members may be reversed such that the first mating member 44 comprises the structure of the second mating member 76 as described above and that the second mating member 76 comprises the structure of the second mating member 44 as described above. Additionally, the coupler 38 may be retained in a fixed position relative to the axle 26 or may be pivotable such that, for example, the post 46 of the first mating member 44 is vertically movable relative to the jack 12.

A grip 88 is attached to the second end 64 of the elongated member 60. As can be seen in FIG. 2, the grip 88 may comprise a bar attached to the second end 64 and orientated perpendicular to the elongated member 60. This allows the user to grip the bar on either side of the elongated member 60. It should be understood that the grip 88 may be positioned adjacent to, but spaced from, the second end 64 a short distance such as less than 1.0 feet though this may be less advantageous during use.

In use, the bracket 34 is attached to the tongue 32 of the trailer 30 and the jack 12 actuated such that the tongue 32 is supported, at a desired height, relative to a floor or ground surface. The user may then attach the handle 52 to the wheel mount 24 with the coupler 38 such that the handle 52 provides the user with the ability to easily turn the wheel mount 24 and thereby direct the wheel(s) 28 in a desired direction. The user may then pull or push on the grip 88 to move the trailer 30 as needed. The length of the handle 52, which is typically at least 4.0 feet, allows for fine adjustments while changing the direction of the wheel(s) 28. Also, the positioning of the grip 88 relative to the trailer 30 provides for more leverage for the user as the trailer 30 is being moved by hand. This allows movement of a trailer 30 and an object thereon without having to secure the trailer 30 to a motorized vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An assembly for assisting a person moving a trailer, the assembly including:
a jack being vertically elongated;
a bracket being attached to the jack and configured to engage a tongue of a trailer;
a wheel mount being attached to and extending downwardly from the jack, the wheel mount being rotatable about a longitudinal axis of the jack when the bracket is attached to the trailer tongue;
at least one wheel being rotatably mounted on an axle of the wheel mount;
a coupler being mounted on the wheel mount; and
a handle being removably coupled to the coupler, the handle being elongated.

2. The assembly for assisting a person moving a trailer according to claim 1, further including:
the jack having a top end and a bottom end and including an upper section and a lower section telescopically coupled to each other, a height of the jack being increased or decreased when the jack is actuated; and
the bracket being positioned on the upper section.

3. The assembly for assisting a person moving a trailer according to claim 1, wherein the at least one wheel comprises a pair of wheels being rotatably mounted on the axle, the wheel mount including a pair of lateral walls, the axle extending through the lateral walls and the wheels being positioned between the lateral walls.

4. The assembly for assisting a person moving a trailer according to claim 3, wherein the coupler includes:
a first mating member;
a central member and a pair of arms extending away from the central member, each of the arms being attached to the axle wherein the lateral walls are positioned between the arms;
the first mating member including a post being attached to the central member, the post extending in an opposite direction from the central member with respect to the arms, the post having a distal end with respect to the central member, a detent being mounted on a peripheral surface of the post and being positioned between the central member and the distal end.

5. The assembly for assisting a person moving a trailer according to claim 1, wherein the is elongated and has a length between 3.0 feet and 6.0 feet, the handle including.

6. The assembly for assisting a person moving a trailer according to claim 1, wherein the handle includes an elongated member having a first end, a second end and a peripheral surface extending between the first and second ends, the peripheral surface having a top side and a bottom side, the top side having a lower bend therein positioned adjacent to the first end, the lower bend forming an angle between 145° and 175°, the top side having an upper bend therein positioned adjacent to the second end, the upper bend forming an angle between 145° and 175°.

7. The assembly for assisting a person moving a trailer according to claim 4, wherein the handle further an elongate member having a first end and a second end, the second end comprising a second mating member configured to releasably engage the first mating member, the second mating member comprising a sleeve for receiving the post, an outer end of the sleeve having a slot extending therein to receiver the detent, the slot having a terminal end, the slot having at least one bend therein to retain the detent in the slot when the detent is abutted against the terminal end.

8. The assembly for assisting a person moving a trailer according to claim 4, wherein the handle includes an elongated member having a first end, a second end and a peripheral surface extending between the first and second ends, the peripheral surface having a top side and a bottom side, the top side having a lower bend therein positioned adjacent to the first end, the lower bend forming an angle between 145° and 175°, the top side having an upper bend therein positioned adjacent to the second end, the upper bend forming an angle between 145° and 175°.

9. The assembly for assisting a person moving a trailer according to claim 8, wherein the handle further an elongate member having a first end and a second end, the second end comprising a second mating member configured to releasably engage the first mating member, the second mating member comprising a sleeve for receiving the post, an outer end of the sleeve having a slot extending therein to receiver the detent, the slot having a terminal end, the slot having at least one bend therein to retain the detent in the slot when the detent is abutted against the terminal end, the top side of the elongated member facing upwardly when the detent abuts the terminal end.

10. The assembly for assisting a person moving a trailer according to claim 9, further including a grip being attached to the second end of the elongated member.

11. A method for moving a trailer comprising the steps of:
providing a trailer having a tongue;
attaching a bracket to the tongue of the trailer, a jack being attached to the bracket and extending downwardly therefrom, a wheel mount being attached to and extending downwardly from the jack, the wheel mount being rotatable about a longitudinal axis of the jack when the bracket is attached to the trailer tongue, at least one wheel being rotatably mounted on an axle of the wheel mount, a coupler being mounted on the wheel mount;
releasably attaching a handle to the coupler such that the handle extends away from the wheel mount, the handle being elongated and including a grip being positioned opposite of the coupler; and
gripping the grip and pulling the handle to in turn pull the trailer.
